(19) United States
(12) Patent Application Publication
(10) Pub. No.: US 2024/0020755 A1
(43) Pub. Date: Jan. 18, 2024

(54) Online Consignment Vehicle Sales System

(71) Applicant: Rodney Kirt Thomason, Tampa, FL (US)

(72) Inventor: Rodney Kirt Thomason, Tampa, FL (US)

(21) Appl. No.: 17/507,942

(22) Filed: Oct. 22, 2021

(51) Int. Cl. G06Q 30/08; G06Q 30/0241

(52) U.S. Cl. CPC G06Q 30/08; G06Q 30/0277

(57) ABSTRACT

A system and method for providing secure sharing of private data, and more specifically, a system and method for providing an on-line consignment vehicle sales application and website is disclosed.

### CROSS-REFERENCES TO RELATED APPLICATIONS

This application claims the benefit of provisional application No. 63/104,366 entitled ONLINE CONSIGNMENT VEHICLE SALES SYSTEM, filed Oct. 22, 2020. The provisional application is incorporated in its entirety by reference.

### FIELD OF INVENTION

This application relates in general to a system and method for the online sale of consigned vehicles, and more specifically, to a system and method for providing an on-line consignment vehicle sales application and website.

### BACKGROUND OF THE INVENTION

Currently, online sales of used vehicles has become part of the sales channel for car dealers and individual sellers to attempt to find buyers for a vehicle and conclude a sale. Various web sites exist that provide listings of available vehicles both from single car dealerships to an aggregation of many sellers onto a single searchable web platform. These listings are generally accessible from any location on the Internet; however current online services typically sell vehicles owned by the dealership.

The sales of used vehicles has many additional steps that need to be accomplished to have the sales process conclude, or payment, provided to the seller and the vehicle delivered to the buyer. These steps are typically performed in person where a buyer visits the seller's location to inspect and test drive the vehicle, a buyer negotiates a price, and a buyer completing the transaction by payment and vehicle delivery. This requirement that the buyers visit the seller's location limits the possible internet buyers from individuals all over the world to a much smaller group of potential buyers close in proximity to the seller.

Additionally, individual sellers typically do not have sufficient experience in the process of preparing a vehicle for sale, advertising the vehicle, and negotiating a best price for the vehicles. Obtaining assistance from an experienced party who engages in the purchase and sale of vehicles allows individual sellers to obtain a sales price that approaches the maximum price available on the market. None of these deficiencies in online vehicle sales processes are adequately met by existing systems.

Therefore, a need exists for a system and method for providing an on-line consignment vehicle sales application and website. The present invention attempts to address the limitations and deficiencies in prior solutions according to the principles and example embodiments disclosed herein.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

In one embodiment, the present invention is a system for providing an on-line consignment vehicle sales application and website.

In another embodiment, the present invention is a method for providing an on-line consignment vehicle sales application and website.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The present invention is described in detail below with reference to the attached drawing figures, wherein:

FIG. 1 illustrates an example embodiment of a system that provides an on-line consignment vehicle sales application and website according to the present invention.

FIG. 2 illustrates an example embodiment of a mobile application vehicle report data screen for providing an on-line consignment vehicle sales application and website according to the present invention.

FIG. 3 illustrates an example embodiment of a mobile application data screen for providing an on-line consignment vehicle sales application and website according to the present invention.

FIG. 4 illustrates a computing system of software components providing an on-line consignment vehicle sales application and website according to the present invention.

FIG. 5 illustrates a flowchart corresponding to a method performed by software components providing an on-line consignment vehicle sales application and website according to the present invention.

FIG. 6 illustrates a generalized schematic of a programmable processing system utilized as the various computing components described herein used to implement an embodiment of the present invention.

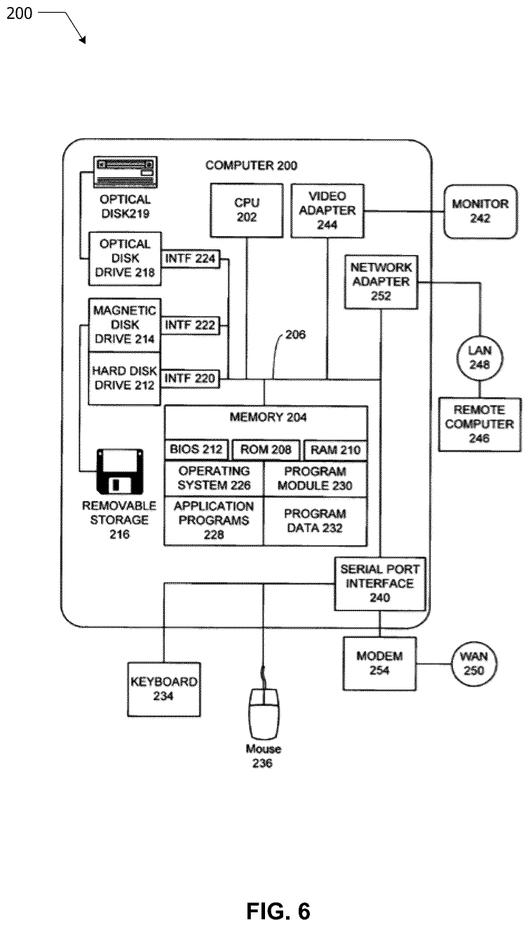

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

The term “mobile application” refers to an application executing on a mobile device such as a smartphone, tablet, and/or web browser on any computing device.

The terms “buyer,” “seller,” and “user” refer to an entity, e.g. a human, using the system and method for providing an on-line consignment vehicle sales application and website including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

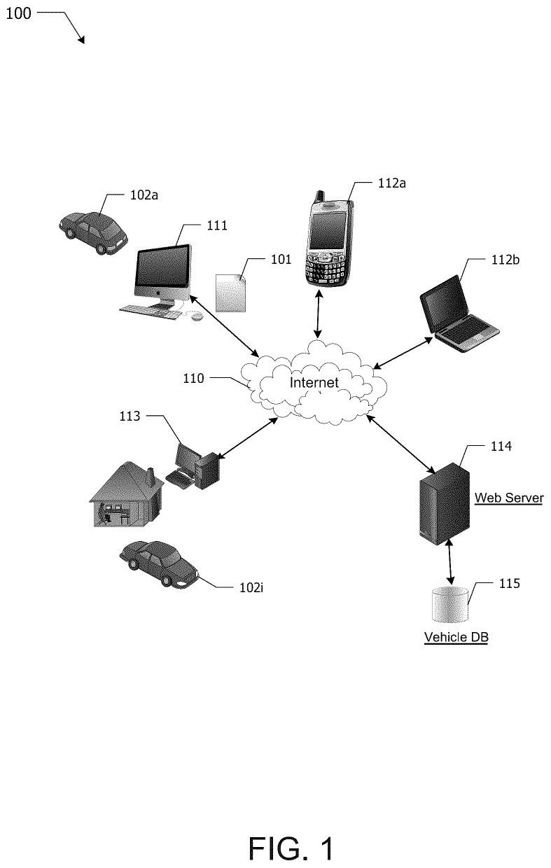

In general, the present disclosure relates to a system and method for providing online consignment vehicle sales. To better understand the present invention, FIG. 1 illustrates an example embodiment of a system that provides an on-line consignment vehicle sales application and website according to the present invention.

Auto dealers help customers sell their used vehicles to various dealers of all types, especially ones that advertise “we buy [any] cars.” These dealers buy the vehicles for a lower wholesale price and turn right around and sell them at local auto auctions for a profit. Other used car dealers may offer to sell an individual's used vehicle on consignment. Regardless of method, the seller is not receiving an amount close to the retail value of the vehicle.

On the other hand, many customers simply do not want to personally sell their vehicles. The sellers do not wish to expend the time, cost, and energy to have the vehicles serviced and detailed before starting any advertising needed to generate potential buyers. These sellers also do not want to be hassled by having to deal with potential buyers of all types: tire kickers coming to their homes to look, low ballers trying to haggle an unfairly low price, and others who have not even decided yet the type, model, and price range of a vehicle they may be interested in purchasing. Additionally, most individuals do not possess the knowledge to set or receive a good retail price for their vehicles.

The Vehicle Sales App 100 acts as a vehicle consignment application in which a seller may simply upload to a web server 114 vehicle information 101 such as photos, miles, and payoff information. With this information 101, a broker can now handle the entire process using experience and superior knowledge to obtain the seller a price closer to a retail amount for the vehicle 102a-i. The entire vehicle search, evaluation, and negotiations may occur online providing sellers access to potential customers all over the world without a cumbersome sales process.

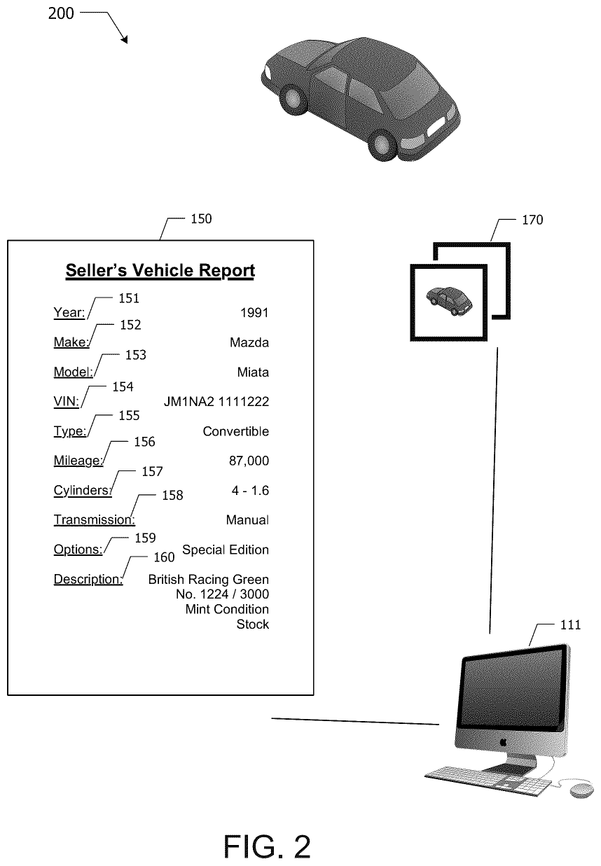

The seller of the vehicle 102a-i will open up the Vehicle Sales App 100. The Vehicle Sales App 100 running on a smartphone or similar mobile device has access to a camera within the smartphone to obtain photographs of the vehicle 102a-i. The Vehicle Sales App presents sellers with a diagram of an example vehicle indicating exactly where desired views of the vehicle 102a-l where photographs are to be taken. The Vehicle Sales App 100 also presents input application screens indicating other information regarding the vehicle 102a-l that is requested from the sellers. The Vehicle Sales App 100 permits the sellers to enter the sellers' information into a vehicle profile 101 that also contains the photographs. This seller's information, which is described below in reference to FIG. 2, may include a Vehicle Identification Number (VIN) number to the car, a statement of the mileage the car has been driven, any loan payoff information, including identity and contact information regarding the lien holder, and the location of a title. The seller may also go on to the website and manually enter the vehicle information and upload photographs.

A completed vehicle profile 101 is sent from the seller to the web server 114 wherein it may be accessed and reviewed by the broker using broker components of the Vehicle Sales App 100. The broker may also obtain the vehicle profile 101 and interact with the web server 114 using a web browser from a broker's computing system 113. The broker may inspect the vehicle profile for accuracy and completeness, perform any desired verification of the vehicle. For example, the broker may desire to obtain a vehicle history report (not shown) from online services such as CarFAX™, AutoCheck™, or similar services. The broker accepts the vehicle for sale by consignment. The seller and broker enter into a consignment sales agreement stating a price, any sales fees to be paid by either party, the broker's fee, and any cancellation terms agreed to by the parties.

The broker using the Vehicle Sales App 100 and web server 114, immediately posts a sales advertisement with online sales listings such as Autotrader™, CarGurus™, and similar online services. The sales advertisements will be displayed on all the online selling sites. The sales advertisement will contain relevant information from the vehicle profile 101 while listing the broker as the responsible seller. At no time is the actual seller identified online or to any buyer.

Buyers may utilize the various online sales listing services to search for and find the vehicle profile 101 including any photographs of the vehicle 102a-i. The broker performs all communication with the buyer regarding any sale using the Vehicle Sales App 100 and the web broker. These communications may include additional information requests, sales and price negotiation, and delivery arrangements. The broker then attempts to sell the car on consignment via online listings and communication.

Once a sales agreement is reached with a buyer, the broker becomes the legal seller of the vehicle 102a-i with respect to this sales agreement. The broker has previously obtained an agreement or option to purchase the vehicle 102a-i from the seller upon completion of a binding sales agreement with a buyer. The broker then pays the seller of the vehicle a sales price of the above sales agreement less any fee paid to the broker, any fees paid for additional inspection(s), repairs, and or detailing, and obtains title to the vehicle. When done, the seller transfers ownership of the vehicle to the broker who in turn transfers ownership to the buyer. If the broker is unable to find a buyer willing to purchase the vehicle 102a-l for an acceptable price, the seller and the broker may cancel their consignment sales agreement and ownership of the vehicle remains in the seller.

As part of its business activities, the broker establishes relationships with various third parties around the country with service facilities to perform inspections and repairs as needed, body shops, and vehicle detailers to prepare the vehicle 102a-i for delivery. This inspection and detailing of the vehicle 102a-i may occur before, during, and after a sales agreement with the buyer is executed. The costs of these inspections, repairs, and detailing are the only upfront expense the seller incurs.

The broker may utilize the Vehicle Sales App 100 and the web server 114 to communicate with the above third parties to perform the inspections, repairs, and detailing, including coordinating the movement of the vehicle from the seller to these third parties. The web server 114 and Vehicle Sales App 100 may maintain contact information for these various third parties to support the above communication.

Payment for the sale of the vehicle is made to broker. The broker, using the web server 114 and Vehicle Sales App 100, then pays off the seller's loan and send any remaining funds from the sale to the seller via a check, ACH electronic payment or similar means. The broker, web server 114 and Vehicle Sales App 100, arranges shipping of the vehicle 102a-i from the seller to the buyer using third party shippers similar to the arrangements described above with respect to other third part service providers. In some situations, the vehicle 102a-i may be shipped to the broker's facility once sold.

During the above process, the web server 114 and Vehicle Sales App 100 is transparent when describing the vehicle based upon current information from the seller, any inspection(s), and repairs. If perhaps there is a problem with the vehicle that causes the buyer to attempt to back out of the sales agreement, the broker, using web server 114 and Vehicle Sales App 100, performs all communication and service arrangements needed to address the issue where the seller is not involved unless there is something that was obvious the seller did not disclose. Using the web server 114 and Vehicle Sales App 100 and the above process, the entire transaction from initial uploading of the vehicle profile to delivery of the vehicle 102a-i is performed with the parties interacting with the web server 114 via the Vehicle Sales App 100 on the parties respective computing devices. None of the parties are required to meet in person as part of the entire transaction. All relevant data related to the vehicle 102a-i, the vehicle profile 101, the various agreements, and all communication is retained within the web server 114 in a searchable database 115. All of this data is available for use by the relevant parties when they are interacting with the web server 114 and Vehicle Sales App 100 during this process.

FIG. 2 illustrates an example embodiment of a mobile application vehicle report data screen for providing an on-line consignment vehicle sales application and website according to the present invention. A vehicle report 150 is shown that a seller creates to identify a vehicle being offered for sale. The report 201 will have a set of standard data fields including: year 151, make 152, model 153, VIN 154, vehicle type 155, current mileage 156, number of cylinders 157, transmission 158, options 159 and a general description 160. The seller also may wish to create user-defined data fields (not shown) to permit unique or lesser used terms to be included in the vehicle report 150 for later searching.

The data from the vehicle report 150 is used to create a vehicle profile 101 that is stored into a vehicle data base 115 on a vehicle profile web server 114. These data fields, including the user defined fields, are entered into a database table containing vehicle profile data organized using these data fields. This arrangement in defining the vehicle profiles may permit potential buyers to search on special features, options and the like in the database efficiently using terms and data fields known to particular sets of buyers without requiring the web server and application to attempt to know all of these data fields that may be desired for all of the different vehicles that may be offered for sale.

For example, owners of specific car models that have a dedicated following may wish to offer to sell and search for vehicles that have such a specialized interest. Consider a popular sports car, a Mazda Miata, that has a large number of used vehicles that are bought and sold in spite of the age of the early models released since 1990. These vehicles are known to Mazda faithful as NAs, NBs, NCs, and NDs, each of which represents a different generation of Miatas that were offered over time. These designations refer to a particular pair of characters in all Miata VIN numbers, but carry unique meaning to Miata buyers and sellers. Additionally, these vehicles, regardless of age, are used for a wide variety of purposes including daily driving, weekend cruising, drifting, motor cross, and racing among many others. The buyers and sellers distinguish these vehicles as being stock, typical for their age, restored, upgraded, etc. The engines and transmissions also may have uniquely identified specifications as known to Miata owners that may relate to turbo chargers, superchargers, 1.6, 1.8, and 2.0 engines, various differentials, oversized and upgraded brakes, and many other terms. The vehicle profile database 115 may run efficiently to support this particular set of active buyers and sellers by permitting these particular features, options, and descriptions to be used in searching for an available vehicle if user-defined data fields and values are included in the vehicle profiles. The user community may agree on a particular set of user-defined fields and corresponding data values that, if used, will permit the identification of available vehicles of interest while the web server 114 and the broker do not need to attempt to standardize these fields and data values which may be described differently by Mustang or Camaro enthusiasts.

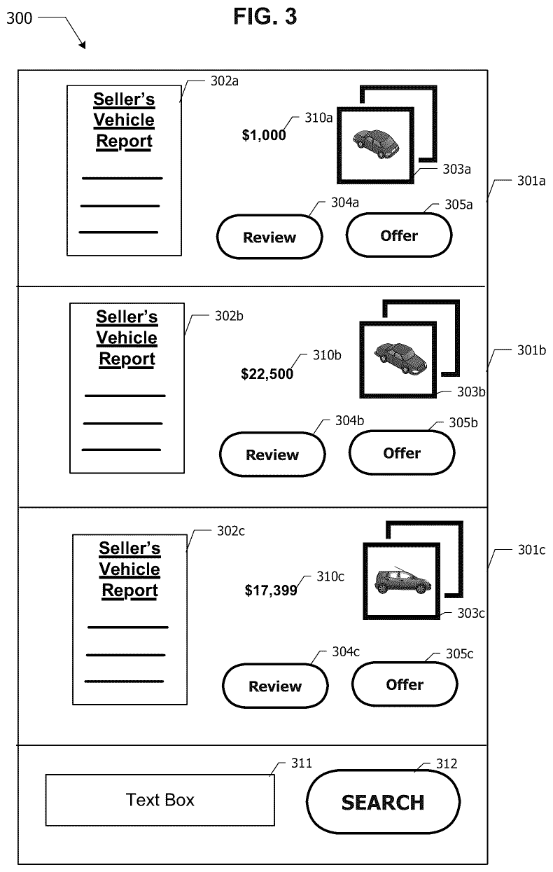

FIG. 3 illustrates an example embodiment of a mobile application data screen for providing an on-line consignment vehicle sales application and website according to the present invention. A set of vehicle search results 301a-c are shown in a web page 300. Each entry 301a-c in the search results includes a written description of the vehicle 302a-c, a set of photographs of the vehicle 303a-c, a starting price 310, a review button 304a-c, and an offer button 305a-c. The web page 300 also includes a search input text box 311 and a search button 312 to narrow and update a vehicle search performed upon vehicle profiles 101 found in a vehicle database 115 attached to the web server.

The written description of the vehicle 302a-c provides a text-based description of the vehicle being offered for sale. The written description 302a-c contains the data fields and contents entered by the seller as discussed above with reference to FIG. 2. The written description 302a-c may also contain seller defined fields of data that offer potential buyers with any and all information they may need to evaluate each vehicle.

The set of photographs of the vehicle 303a-c correspond to the one or more photographs that the seller uploads to the vehicle profile 101 as disclosed in reference to FIG. 2 above. The seller may take photographs of the actual vehicle being offered for sale, stock photos of the make and model of the vehicle, and any combination thereof to inform potential buyers of the vehicle being offered for sale by the seller.

The starting price 310a-c corresponds to a price value that the seller may set for a desired amount when any negotiations start. While the starting price 310a-c initially may be set by the seller when the vehicle profile is first created, the price 310a-c may also be defined and set, both above and below the seller's starting price by the broker who is assisting the seller and attempting to obtain the best deal for his client. The broker may also lower the starting price 310a-c over time in an attempt to stimulate interest in the vehicle from potential buyers.

The review button 304a-c provides the buyer with a UI element to request a detailed web page describing the vehicle selected by the buyer for review. In some embodiments, this review button 311a-c may present a pop-up menu that provides the buyer an ability to view, print, and share a vehicle profile using email, SMS text messages, and other messaging programs.

The offer button 305a-c provides a buyer with a UI element to begin communications with the broker to negotiate a purchase price and subsequent agreement for the vehicle. The initial offer may be provided using a message from a buyer messenger 426 within the Vehicle Sales App 100. The offer may also be created using a template in which the buyer enters data into a form agreement that may include other terms such as delivery, warrantee, inspection, and price. The parties may exchange forms of this agreement as necessary to finalize and execute a binding contract.

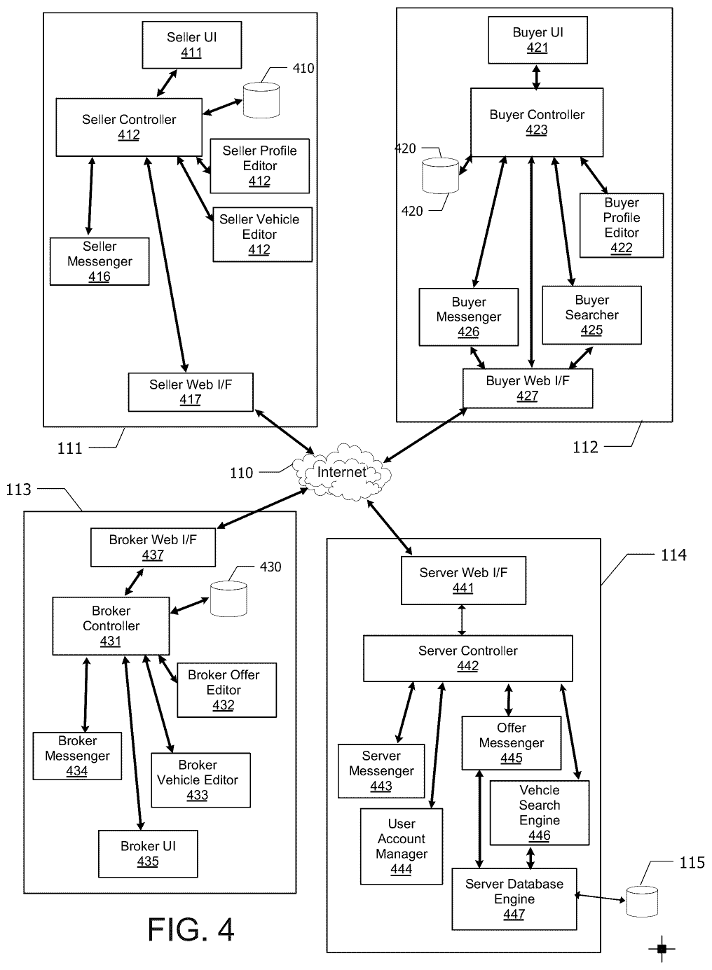

FIG. 4 illustrates a computing system of software components providing an on-line used vehicle sales broker application and website according to the present invention. FIG. 4 shows the software components running in the Vehicle Sales App 100 when the application is running on a seller device 111, software components running in the Vehicle Sales App 100 when the application is running on a buyer device 112, and the software components running on the vehicle web server 114. Each of these sets of components are described herein.

The Vehicle Sales App 100 running on a user device as a seller device 111 comprises a seller UI 411, a seller profile editor 412, a seller messenger 416, a seller web interface 417, and a seller local data store 410. The seller UI 411 module provides input and output processing to the seller device 111 with messages and data needed to receive and process the vehicle profile 101. The seller UI 411 also allows the seller device 111 to enter data into a vehicle profile 101 template and create a password 402 used to create the encrypted vehicle profile 101 that is sent to the vehicle web server 114.

The seller vehicle profile editor 412 provides the seller an ability to create and maintain a vehicle profile 101 for the vehicle offered for sale. As noted with respect to FIGS. 2-3, the seller vehicle profile editor 412 presents a user with an empty template of data fields for the vehicle profile 101. The seller may send the seller vehicle profile editor 412 commands from the seller UI 411 to select and delete any data field in the initial template as well as a previously created vehicle profile 101. The seller also may enter data via the seller UI 411 to define and insert the personal data to be stored within the selected data fields.

The seller vehicle profile editor 412 also provides the seller with an ability to create user-defined data fields in which the seller defines both the label associated with the data field and its contents. The label data provides a buyer receiving and reading the vehicle profile 101 with useful information defining and clarifying the potential use and need for the data in the associated field when caring for the vehicle offered for sale. The seller vehicle profile editor 412 may be used by the seller to review the current contents of the vehicle profile 101 without actually changing any of the data. The seller vehicle profile editor 412 may require use of a user password or biometric authentication to protect the improper editing of the vehicle profile 101 data by someone other than an authorized user.

The seller vehicle profile editor 412 may be configured to trigger the generation of the new encrypted vehicle profile 101 data file on a periodic basis or to trigger generation of a new encrypted vehicle profile 101 data file after a predetermined amount of time after the seller stops using the seller vehicle profile editor 412. This short time delay prevents the generation of an encrypted vehicle profile 101 data file for each edit performed by the seller vehicle profile editor 412 by waiting until the user appears to be done editing the vehicle profile 101 and its corresponding alarms. This time delay typically is only a short time measured in minutes to ensure that the most current data is contained within the data files on the vehicle web server 114 so that the buyer will receive the updates in a timely fashion. The seller may use the seller vehicle profile editor 412 to define when the new encrypted data file is to be generated.

The seller messenger 416 sends the encrypted vehicle profile 101 data files to the vehicle web server 114. The seller messenger 416 will transmit the data files whenever the seller explicitly instructs the Vehicle Sales App 100 via the seller UI 411 to send and update the vehicle profile 101 on the vehicle web server 114. The seller messenger 416 also sends any updated encrypted vehicle profile 101 data files to the vehicle web server 114 after the seller has edited the vehicle profile 101. The seller messenger 416 may be configured to continue to try to send the encrypted data file to the vehicle web server 114 until the server sends a confirmation message that the encrypted data file has been received and stored for use by the buyer device 112.

When the seller messenger 416 is unable to transmit the encrypted vehicle profile 101 data file to the vehicle web server 114 for any reason, the seller messenger 416 may retry to transmit the encrypted data file after a predetermined delay, at a scheduled time, or continuously until it is successful. This retry process may occur both when the vehicle web server 114 does not respond to communication from the seller device 111 such as when the vehicle web server 114 is offline, as well as when the vehicle web server 114 cannot receive an error-free copy of the encrypted data file. The seller may be provided an error message via the seller UI 411 when the encrypted data cannot currently be transmitted to the vehicle web server 114. A successful transmission message also may be provided to the seller when the vehicle web server 114 acknowledges receipt of the data file.

The seller web interface 417 permits the seller device 111 to communicate with the vehicle web server 114. The web interface 417 performs all of the data formatting, computer to computer communications, encryption processing, and all similar operations needed by the web server to communicate with users using the Internet 110.

The seller local data store 410 provides permanent data storage on the seller device 111 used by the Vehicle Sales App 100 as it operates as a seller device 111. The seller local data store 410 may contain vehicle profiles, application data, previously entered passwords, and all other data needed to operate. This seller local data store 410 may be located in the internal SSD storage devices typically inside a smartphone or tablet. The seller local data store 410 may be stored on hard drives and other permanent storage devices on laptop and desktop computers.

The Vehicle Sales App 100 running on a user device as a buyer device 112 comprises a buyer UI 421, a buyer vehicle profile reader 422, a buyer alarm manager 423, a QR reader 424, a buyer decryption processor 425, a buyer messenger 426, a buyer web interface 427, and a buyer local data store 420. The buyer UI 421 module provides input and output processing to the buyer device 112 with messages and data needed to receive and process the vehicle profile 101.

The buyer profile reader 422 receives a decrypted and validated data package decoded from the QR-code for display to the buyer via the buyer web interface 427. The buyer vehicle profile reader 422 verifies whether or not the decrypted and validated data package contains a valid web link URL to the vehicle web server 114 and uses the URL to obtain the complete encrypted vehicle profile 101 data file from the vehicle web server 114. The buyer vehicle profile reader 422 sends the request to download the encrypted vehicle profile 101 data file to the buyer messenger 426 and receives the data file from the messenger when it is received. The buyer vehicle profile reader 422 working with the buyer decryption processor 425 uses the password 402 to decrypt the encrypted vehicle profile 101 data file. The resulting data from the vehicle profile 101 may now be presented to the buyer via the buyer UI 421.

The buyer decryption processor 425 receives and decrypts an encrypted vehicle profile 101 data file from the buyer messenger 426 after receipt from the vehicle web server 114. The buyer decryption processor 425 may request the password 402 from the buyer via the buyer UI 421 for use in decrypting the encrypted data file. The buyer decryption processor 425 may store the password 402 within the buyer local data store 420 for later use. The buyer decryption processor 425 also may retrieve a previously stored copy of the password 402 when the buyer decryption processor 425 is processing an automatically-generated encrypted vehicle profile 101 data file retrieved from the vehicle web server 114. The buyer decryption processor 425 may assume that the new encrypted data was generated by the seller device 111 and sent to the vehicle web server 114 when the seller edited the vehicle profile 101.

The buyer decryption processor 425 may use a known encryption method to decrypt the data received from the vehicle web server 114 so long as it matches the encryption method used by the seller encryption processor 415 when creating the encrypted data files.

The buyer messenger 426 receives the encrypted vehicle profile 101 data files from the vehicle web server 114 for use by the buyer app 100. The buyer messenger 426 may receive a copy of the encrypted vehicle profile 101 data file when the buyer first connects to the vehicle web server 114 after the buyer searches for a vehicle profile. A web search of the web server 114 typically is intended for the buyer device 112 to obtain the vehicle profile 101 for the vehicle being offered for sale. The encrypted data file is upon receipt sent to the buyer decryption processor 425 for further processing.

The buyer messenger 426 also may retrieve the vehicle profile 101 data file when the buyer messenger 426 determines that the vehicle web server 114 has a new version of the vehicle profile 101 than has been previously downloaded. The buyer messenger 426 may check with the vehicle web server 114 for an updated encrypted data file each time the Vehicle Sales App 100 is launched. The buyer messenger 426 may periodically check for an updated encrypted data file using a predetermined schedule. This predetermined schedule may be defined by requesting an update check after a defined amount of time has passed since the last time the status of the data file was checked. The predetermined schedule also may be on a specified time schedule such as 10 minutes after the top of each hour or each morning at 7:30 am and several other times throughout the day. The buyer messenger 426 checks the vehicle web server 114 for an updated encrypted data file so that the latest vehicle profile 101 from the seller device 111 is available for use within the buyer device 112 without the buyer needing to check for an update. The automatic checking and downloading of the vehicle profile 101 data file provides both the seller and the buyer assurance that edits to the vehicle profile 101 are available for use as quickly as possible.

The buyer web interface 427 permits the buyer device 112 to communicate with the vehicle web server 114. The web interface 427 performs all of the data formatting, computer to computer communications, encryption processing, and all similar operations needed by the buyer device 112 to communicate with the vehicle web server 114 over the Internet 110.

The buyer local data store 420 provides permanent data storage on the buyer device 112 used by the Vehicle Sales App 100 as it operates on a buyer device 112. The buyer local data store 420 may contain prior vehicle profiles, application data, previously entered passwords, and all other data needed to operate. This buyer local data store 420 may be located on the internal SSD storage devices typically inside a smartphone or tablet. The buyer local data store 420 may be stored on hard drives and other permanent storage devices on laptop and desktop computers.

The Vehicle Sales App 100 running on a user device as a broker device 113 comprises a broker UI 435, a broker vehicle profile editor 433, a broker offer editor 432, a broker messenger 343, a broker web interface 437, and a broker local data store 430. The broker UI 435 module provides input and output processing to the broker device 113 with messages and data needed to receive and process the vehicle profiles 101. The broker UI 435 also allows the broker device 113 to enter data into a vehicle profile 101 template and create a password 402 used to create the encrypted vehicle profile 101 that is sent to the vehicle web server 114.

The broker vehicle profile editor 433 provides the broker an ability to create and maintain a vehicle profile 101 for the vehicles for sale. As noted with respect to FIGS. 2-3, the broker vehicle profile editor 433 presents a user with an empty template of data fields for the vehicle profile 101. The broker may send the broker vehicle profile editor 433 commands from the broker UI 411 to select and delete any data field in the initial template as well as a previously created vehicle profile 101. The broker also enter data via the broker UI 435 to define and insert the personal data to be stored within the selected data fields.

The broker vehicle profile editor 433 also provides the broker with an ability to create user-defined data fields in which the broker defines both the label associated with the data field and its contents. The label data provides a buyer receiving and reading the vehicle profile 101 with useful information defining and clarifying the potential use and need for the data in the associated field when considering the vehicle. The broker vehicle profile editor 433 may be used by the broker to review the current contents of the vehicle profile 101 without actually changing any of the data. The broker vehicle profile editor 433 may require use of a user password or biometric authentication to protect the improper editing of the vehicle profile 101 data by someone other than an authorized user.

The broker vehicle profile editor 433 may be configured to trigger the generation of the new encrypted vehicle profile 101 data file on a periodic basis or to trigger a generation of a new encrypted vehicle profile 101 data file after a predetermined amount of time after the broker stops using the broker vehicle profile editor 433. This short time delay prevents the generation of an encrypted vehicle profile 101 data file for each edit performed by the broker vehicle profile editor 433 by waiting until the user appears to be done editing the vehicle profile 101. This time delay typically is only a short time measured in minutes to ensure that the most current data is contained within the data files on the vehicle web server 114 so that the buyer will receive the updates in a timely fashion. The broker may use the broker vehicle profile editor 433 to define when the new encrypted data file is to be generated.

The broker messenger 434 sends the encrypted vehicle profile 101 data files to the vehicle web server 114. The broker messenger 434 will transmit the data files whenever the broker explicitly instructs the Vehicle Sales App 100 via the broker UI 435 to send and update the vehicle profile 101 on the vehicle web server 114. The broker messenger 434 also sends any updated encrypted vehicle profile 101 data files to the vehicle web server 114 after the broker has edited the vehicle profile 101. The broker messenger 434 may be configured to continue to try to send the encrypted data file to the vehicle web server 114 until the server sends a confirmation message that the encrypted data file has been received and stored for use by the buyer device 112.

When the broker messenger 434 is unable to transmit the encrypted vehicle profile 101 data file to the vehicle web server 114 for any reason, the broker messenger 434 may retry to transmit the encrypted data file after a predetermined delay, at a scheduled time or continuously until it is successful. This retry process may occur both when the vehicle web server 114 does not respond to communication from the broker device 113 such as when the vehicle web server 114 is offline, as well as when the vehicle web server 114 cannot receive an error-free copy of the encrypted data file. The broker may be provided an error message via the broker UI 435 when the encrypted data cannot currently be transmitted to the vehicle web server 114. A successful transmission message also may be provided to the broker when the vehicle web server 114 acknowledges receipt of the data file.

The broker offer editor 432 receives messages from the buyer device 112 and the seller device 111 regarding a vehicle profile 101 in which the buyer has an interest to purchase the vehicle from the seller. The broker utilizes the broker offer editor 432 to create an offer which is sent to the buyer 112 using a message sent between the broker messenger 434 and the buyer messenger 426. The broker, acting on behalf of the seller, negotiates a purchase agreement which is ultimately presented to the seller for approval via the seller messenger 416. Once the approval of the purchase agreement has been made, written agreements in electronic form are exchanged and executed. Terms for payment and timing of vehicle delivery are contained within the purchase agreement. The broker monitors and assists in the completion of the sale and delivery of the vehicle from the seller to the buyer using the broker offer editor 432.

The broker web interface 437 permits the broker device 113 to communicate with the vehicle web server 114. The web interface 437 performs all of the data formatting, computer to computer communications, encryption processing, and all similar operations needed by the web server to communicate with users using the Internet 110.

The broker local data store 430 provides permanent data storage on the broker device 113 used by the Vehicle Sales App 100 as it operates as a broker device 113. The broker local data store 430 may contain vehicle profiles, application data, previously entered passwords, and all other data needed to operate. This broker local data store 430 may be located on the internal SSD storage devices typically inside a smartphone or tablet. The broker local data store 430 may be stored on hard drives and other permanent storage devices on laptop and desktop computers.

The software components running on the vehicle web server 114 consist of a seller UI 411, a user to server messenger 442, a user account manager 443, and a server database engine 444 coupled to an external storage device containing a vehicle profile database 115. The server web interface 441 permits the vehicle web server 114 to communicate with remote users' computing devices such as the seller device 111 and buyer device 112 over the Internet 110. The web interface performs all of the data formatting, computer to computer communications, encryption processing, and all similar operations needed by the web server to communicate with users on the Internet 110.

The user to server messenger 442 permits the vehicle web server 114 to communicate between the seller device 111 and the buyer device 112. The user to server messenger 442 performs all of the data formatting, computer to computer communications, encryption processing, and all similar operations needed by the buyer device 112 to communicate with the seller device 111 over the Internet 110.

The user account manager 443, permits users to connect to and access the vehicle web server 114. The user account manager 443 is responsible for creating and managing user accounts for seller devices 111 and buyer devices 112. The user account manager 443 also is used in authenticating a user based upon user input. Typically, the user input uses a username and password. Multi-factor authentication, use of one-time passwords, and similar secure authentication mechanisms may be included in the user profile. For every sign-in the system will recognize the user type, i.e. seller device 111 and buyer device 112, along with all past activities from account details in the database. Based on user type, the vehicle web server 114 behavior will change.

The server database engine 444 coupled to an external storage device containing a vehicle profile database 115 processes all database operations for the vehicle profile database 115. These operations include insertion of vehicle profiles 101 into the vehicle profile file database 115, deletion of the vehicle profiles 101 from the vehicle profile database 115, searching and retrieving vehicle profiles 101 from the vehicle profile database 115, and indexing the database 101 to maintain efficient searching when needed.

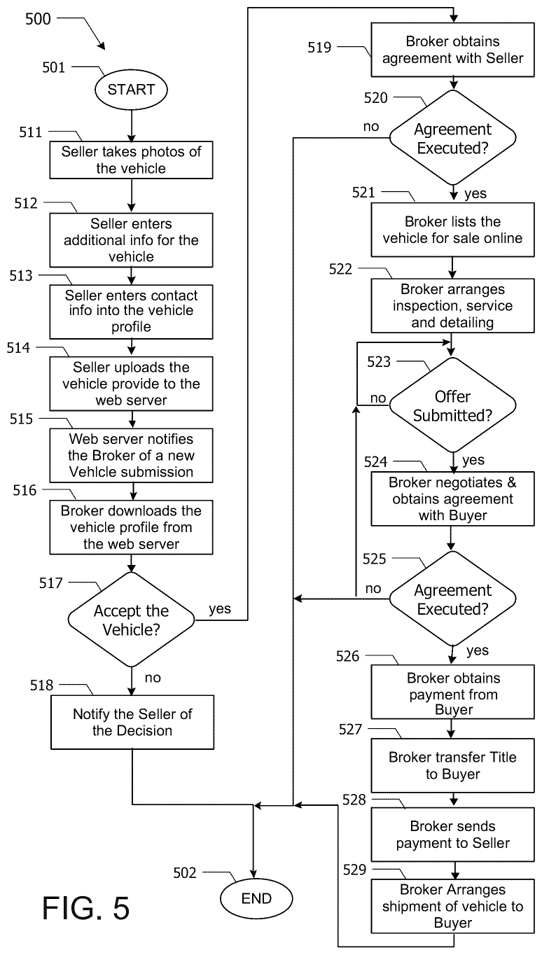

FIG. 5 illustrates a flowchart corresponding to a method performed by software components providing an on-line used vehicle sales broker application and website according to the present invention. The process 500 begins 501 where a seller of a vehicle downloads the Vehicle Sales App 100 and takes a set of vehicle photographs of the vehicle being offered for sale in step 511. The Vehicle Sales App 100 may provide instructions and diagrams indicating desired view to be obtained of the vehicle that provide sellers with an informed recommendation of various views of the vehicle which may assist in obtaining potential buyers.

In step 512, the seller enters additional information into the Vehicle Sales App 100 that is included in a vehicle profile that will be used in the advertisement and sale of the vehicle. In step 513, the seller enters into the Vehicle Sales App 100 contact information for parties to contact and communicate with the seller regarding the sale of the vehicle. All of this information and photographs are combined to create the vehicle profile that is uploaded to a web server in step 514. The web server is operated on behalf a vehicle sales broker who will assist the seller in the sales process. The web server, in step 515, notifies the broker that a new vehicle profile has been submitted by a seller, and in step 516, the broker downloads the vehicle profile from the web server for consideration. Using the information in the vehicle profile, and any investigation and confirmation of the data in the vehicle profile, the broker decides in test step 517, whether to accept the vehicle for inclusion into vehicles that broker is offering for sale. When the broker decides in test step 517 that the vehicle is not acceptable for sale by the broker, the broker provides notification of the decision in step 518, and process 500 ends 502.

When the broker decides in test step 517 that the vehicle is acceptable for sale by the broker, the broker obtains the conditional sales agreement in step 519 with the seller that binds the seller to complete the sale of the vehicle when an acceptable sale price is obtained by the broker from a willing buyer. This conditional sales agreement may contain a time period for the agreement to be in force, a minimum acceptable purchase price for the vehicle, a fee arrangement for any costs and services provided by the broker and additional third parties, and a cancelation arrangement in which either the broker or the buyer may terminate the agreement. Test step 520 determines whether the broker and seller execute the conditional sales agreement, and if not, the process end 502.

Once the conditional sales agreement is executed and entered into the Vehicle Sales App 100, the broker in step 521 posts the vehicle profile and photographs in an appropriate format onto one or more online vehicle listing platforms. The listing for the vehicle is now available for discovery and review by users across the Internet. In step 522, the broker contacts third party provides to inspect the vehicle, service the vehicle as needed, and detail the vehicle to present it in the best condition. Any information regarding the vehicles, including additional photographs once the vehicle has been detailed may be used to update the vehicle profile and listing on the various listing sites.

The process 500 waits for a potential buyer to submit an offer to purchase the vehicle in test step 523. The process 500 remains in test step 523 until an offer is submitted or until the vehicle is removed from the marketplace. Once the offer is received, the broker communicates with the potential buyer in step 524 to negotiate and reach an agreement regarding all of terms of a sales agreement. Test step 525 determines whether the negotiations ended in an executed agreement, and if not the process returns to step 523 to wait for additional sale offers. The process 500 may also end 502 upon the failure to obtain an executed sales agreement is specified in the conditional sales agreement between the seller and the broker.

Once the agreement is executed, the broker obtains payment from the buyer in step 526. This payment may require assisting the buyer in obtaining financing from a lender for the purchase price of the vehicle and associated fees less any down payment. At the same time, the broker in step 527, obtains title to the vehicle from the seller, including satisfying any monies still owed to release a financier's lien. The broker sends the funds from the sale to the seller in step 528. The amount of funds paid in step 528 are defined in the conditional sales agreement between the seller and the broker that may deduct costs incurred by the broker in selling the vehicle and deduct any broker fees earned by the broker in completing the sale.

The broker concludes the process 500 when the vehicle has been successfully shipped from its present location to the buyer in step 529. The vehicle may not be considered successfully delivered in step 529 if the buyer has any legitimate objections to the vehicle regarding its matching the description provided by the seller in the vehicle profile as well as any damage suffered by the vehicle between when it was listed and delivered. The broker and the buyer may make additional arrangements to address any objections made by the buyer. The negotiated sales agreement between the broker and the buyer determines when an objection is legitimate. With the vehicle in the possession of the buyer and title passed to the buyer, including any liens for a finance entity providing the buyer funds to make the purchase, the process 500 ends 502

The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 also may be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of the computer system 200. Rather the computer system 200 is provided as an example of one type of computing device that may be adapted to perform the functions of a secure sharing of private data system, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional unrecited elements or steps do not have the one or more specified characteristics.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A system for providing online consignment vehicle sales comprising:
a web server;
a vehicle consignment application running on a mobile device,
wherein the vehicle consignment application enables a user upload vehicle information to the web server,
wherein the vehicle consignment application further presents input application screens in; and
a broker component running on at least one of a mobile device and a computing system,
wherein the broker component is enabled to obtain the vehicle information and post sales advertisement with one or more online sales listings.

2. The system of independent claim 1, wherein:
wherein the vehicle information comprises at least one of a vehicle profile and a vehicle history report.

3. A system for providing online consignment vehicle sales comprising:
a vehicle consignment application running on a seller device comprising:
a seller user interface,
a seller profile editor,
a seller messenger,
a seller web interface, and
a seller local data store;
a broker component running on a buyer device;
a web server

4. The system of independent claim 3, wherein:
the seller user interface provides messages and data needed to receive and process a vehicle profile.

5. The system of claim 4, wherein:
the seller user interface further allows the seller device to enter data into a template for the vehicle profile.
